(19) United States
(12) Patent Application Publication
(10) Pub. No.: US 2026/0204214 A1
(43) Pub. Date: Jul. 16, 2026

(54) PIXEL DRIVING CIRCUIT, DRIVING METHOD THEREOF, DISPLAY PANEL AND DISPLAY APPARATUS

(71) Applicants: Chengdu BOE Optoelectronics Technology Co., Ltd., Chengdu, Sichuan (CN); BOE TECHNOLOGY GROUP CO., LTD., Beijing (CN)

(72) Inventors: Xin YE, Beijing (CN); Maolin ZHOU, Beijing (CN); Yonglong MA, Beijing (CN); Xiangpeng LIU, Beijing (CN); Bo YANG, Beijing (CN)

(73) Assignees: Chengdu BOE Optoelectronics Technology Co., Ltd., Chengdu, Sichuan (CN); BOE TECHNOLOGY GROUP CO., LTD., Beijing (CN)

(21) Appl. No.: 19/135,102

(22) PCT Filed: Nov. 9, 2023
(86) PCT No.: PCT/CN2023/130760

§ 371 Date: Jun. 3, 2025

(30) Foreign Application Priority Data
Dec. 26, 2022 (CN) 202211679463.6

(51) Int. Cl. G09G 3/3233

(52) U.S. Cl. CPC G09G 3/3233; G09G 2300/0819; G09G 2300/0842; G09G 2310/08; G09G 2320/045

(57) ABSTRACT

A pixel driving circuit is configured for driving a light-emitting unit to emit light. The pixel driving circuit includes a first driving transistor and a current compensation circuit. A first electrode of the first driving transistor is connected to a first power terminal, a second electrode thereof is connected to a first electrode of the light-emitting unit, and a gate electrode thereof is connected to a first node. The current compensation circuit and the first driving transistor are connected in parallel between the first power terminal and the first electrode of the light-emitting unit, and the current compensation circuit is configured to provide, in response to a control signal, a driving current to the light-emitting unit through the first power terminal.

### CROSS-REFERENCE TO RELATED APPLICATIONS

The present application is a U.S. national phase application of International Application No. PCT/CN2023/130760, filed on Nov. 9, 2023, which claims priority to Chinese Patent Application No. 202211679463.6, filed on Dec. 26, 2022 and entitled “PIXEL DRIVING CIRCUIT, DRIVING METHOD THEREOF, DISPLAY PANEL AND DISPLAY APPARATUS”, the entire contents of each are incorporated herein by reference as part of the present disclosure.

### TECHNICAL FIELD

The present disclosure relates to the field of display technology, in particular, to a pixel driving circuit, a driving method of the pixel driving circuit, a display panel, and a display apparatus.

### BACKGROUND

The display panel needs to undergo the lifetime aging (L-Aging) process and/or a reverse aging process before leaving the factory. In the lifetime aging (L-Aging) process, the light-emitting unit is driven to emit light and rapidly ages, so that the display panel is in a relatively stable state after leaving the factory. The reverse aging process provides a large driving current to the light-emitting unit to melt impurity conductive structures in the cathode and the anode of the light-emitting unit, thereby avoiding a short circuit in the light-emitting unit caused by the impurity conductive structures.

It should be noted that the information disclosed in the above section is only intended to enhance the understanding of the background of the present disclosure, and thus can include information that does not constitute the prior art already known to those skilled in the art.

### SUMMARY

According to one aspect of the present disclosure, a pixel driving circuit is provided. The pixel driving circuit is configured to drive a light-emitting unit to emit light, and the pixel driving circuit includes: a first driving transistor, wherein a first electrode of the first driving transistor is connected to a first power terminal, a second electrode of the first driving transistor is connected to a first electrode of the light-emitting unit, and a gate of the first driving transistor is connected to a first node; and a current compensation circuit, wherein the current compensation circuit is connected in parallel to the first driving transistor between the first power terminal and the first electrode of the light-emitting unit, and is configured to provide, in response to a control signal, a driving current to the light-emitting unit through the first power terminal.

In some embodiments of the present disclosure, the current compensation circuit includes one or more parallel second driving transistors, wherein a first electrode of the second driving transistor is connected to the first electrode of the first driving transistor, a second electrode of the second driving transistor is connected to the second electrode of the first driving transistor, and a gate of the second driving transistor is connected to the first node.

In some embodiments of the present disclosure, the pixel driving circuit further includes: a first light-emitting control circuit, wherein the first light-emitting control circuit is connected to the first power terminal and the first electrode of the first driving transistor, and is configured to connect, in response to a control signal, the first power terminal and the first electrode of the first driving transistor; and wherein the current compensation circuit further includes: a second light-emitting control circuit, wherein the second light-emitting control circuit is connected to the first power terminal and the first electrode of the first driving transistor, and is configured to connect, in response to a control signal, the first power terminal and the first electrode of the first driving transistor.

In some embodiments of the present disclosure, the pixel driving circuit further includes: a third light-emitting control circuit, wherein the third light-emitting control circuit is connected to the first electrode of the light-emitting unit and the second electrode of the first driving transistor, and is configured to connect, in response to a control signal, the second electrode of the first driving transistor and the first electrode of the light-emitting unit; and wherein the current compensation circuit further includes: a fourth light-emitting control circuit, wherein the fourth light-emitting control circuit is connected to the first electrode of the light-emitting unit and the second electrode of the first driving transistor, and is configured to connect, in response to a control signal, the second electrode of the first driving transistor and the first electrode of the light-emitting unit.

In some embodiments of the present disclosure, in the case that the pixel driving circuit further includes a first light-emitting control circuit, the current compensation circuit further includes a second light-emitting control circuit; the first light-emitting control circuit is further connected to a first enabling signal terminal, and is configured to connect, in response to a signal on the first enabling signal terminal, the first power terminal and the first electrode of the first driving transistor; the second light-emitting control circuit is further connected to the first enabling signal terminal, and is configured to connect, in response to the signal on the first enabling signal terminal, the second electrode of the first driving transistor and the first electrode of the light-emitting unit; the third light-emitting control circuit is further connected to the first enabling signal terminal, and is configured to connect, in response to the signal on the first enabling signal terminal, the first power terminal and the first electrode of the first driving transistor; and the fourth light-emitting control circuit is further connected to the first enabling signal terminal, and is configured to connect, in response to the signal on the first enabling signal terminal, the second electrode of the first driving transistor and the first electrode of the light-emitting unit.

In some embodiments of the present disclosure, the first light-emitting control circuit includes: a fifth transistor, wherein a first electrode of the fifth transistor is connected to the first power terminal, a second electrode of the fifth transistor is connected to the first electrode of the first driving transistor, and a gate of the fifth transistor is connected to the first enabling signal terminal; the second light-emitting control circuit includes: one or more parallel eighth transistors, wherein a first electrode of the eighth transistor is connected to the first electrode of the fifth transistor, a second electrode of the eighth transistor is connected to the second electrode of the fifth transistor, and a gate of the eighth transistor is connected to the first enabling signal terminal; the third light-emitting control circuit includes: a sixth transistor, wherein a first electrode of the sixth transistor is connected to the second electrode of the first driving transistor, a second electrode of the sixth transistor is connected to the first electrode of the light-emitting unit, and a gate of the sixth transistor is connected to the first enabling signal terminal; and the fourth light-emitting control circuit includes: one or more parallel ninth transistors, wherein a first electrode of the ninth transistor is connected to the first electrode of the sixth transistor, a second electrode of the ninth transistor is connected to the second electrode of the sixth transistor, and a gate of the ninth transistor is connected to the first enabling signal terminal.

In some embodiments of the present disclosure, width-length ratios of channel regions of the fifth transistor, the sixth transistor, the eighth transistor, and the ninth transistor are approximately the same, and width-length ratios of channel regions of the first driving transistor and the second driving transistor are approximately the same; the width-length ratio of the channel region of any one of the fifth transistor, the sixth transistor, the eighth transistor, and the ninth transistor is greater than the width-length ratio of the channel region of any one of the first driving transistor and the second driving transistor.

In some embodiments of the present disclosure, the current compensation circuit includes one or more parallel tenth transistors, wherein a first electrode of the tenth transistor is connected to the first power terminal, a second electrode of the tenth transistor is connected to the first electrode of the light-emitting unit, and a gate of the tenth transistor is connected to a second enabling signal terminal.

In some embodiments of the present disclosure, a width-length ratio of a channel region of the tenth transistor is greater than a width-length ratio of a channel region of the first driving transistor.

In some embodiments of the present disclosure, the pixel driving circuit further includes: a data writing circuit connected to the first electrode of the first driving transistor, a data signal terminal, and a gate driving signal terminal, and configured to transmit, in response to a signal on the gate driving signal terminal, a signal on the data signal terminal to the first electrode of the first driving transistor; a first light-emitting control circuit connected to the first power terminal, the first electrode of the first driving transistor, and a first enabling signal terminal, and configured to connect, in response to a signal on the first enabling signal terminal, the first power terminal and the first electrode of the first driving transistor; a third light-emitting control circuit connected to the first electrode of the light-emitting unit, the second electrode of the first driving transistor, and the first enabling signal terminal, and configured to connect, in response to the signal on the first enabling signal terminal, the second electrode of the first driving transistor and the first electrode of the light-emitting unit; a compensation circuit connected to the first node, the second electrode of the first driving transistor, and the gate driving signal terminal, and configured to connect, in response to the signal on the gate driving signal terminal, the first node and the second electrode of the first driving transistor; a first reset circuit connected to a first initial signal terminal, the first node, and a first reset signal terminal, and configured to transmit, in response to a signal on the first reset signal terminal, a signal on the first initial signal terminal to the first node; a second reset circuit connected to the first electrode of the light-emitting unit, a second initial signal terminal, and a second reset signal terminal, and configured to transmit, in response to a signal on the second reset signal terminal, a signal on the second initial signal terminal to the first electrode; and a storage circuit connected between the first node and the first power terminal.

In some embodiments of the present disclosure, the data writing circuit includes: a fourth transistor, wherein a first electrode of the fourth transistor is connected to the data signal terminal, a second electrode of the fourth transistor is connected to the first electrode of the first driving transistor, and a gate of the fourth transistor is connected to the gate driving signal terminal; the first light-emitting control circuit includes: a fifth transistor, wherein a first electrode of the fifth transistor is connected to the first power terminal, a second electrode of the fifth transistor is connected to the first electrode of the first driving transistor, and a gate of the fifth transistor is connected to the first enabling signal terminal; the third light-emitting control circuit includes: a sixth transistor, wherein a first electrode of the sixth transistor is connected to the second electrode of the first driving transistor, a second electrode of the sixth transistor is connected to the first electrode of the light-emitting unit, and a gate of the sixth transistor is connected to the first enabling signal terminal; the compensation circuit includes: a second transistor, wherein a first electrode of the second transistor is connected to the first node, a second electrode of the second transistor is connected to the second electrode of the first driving transistor, and a gate of the second transistor is connected to the gate driving signal terminal; the first reset circuit includes: a first transistor, wherein a first electrode of the first transistor is connected to the first initial signal terminal, a second electrode of the first transistor is connected to the first node, and a gate of the first transistor is connected to the first reset signal terminal; the second reset circuit includes: a seventh transistor, wherein a first electrode of the seventh transistor is connected to the second initial signal terminal, a second electrode of the seventh transistor is connected to the first electrode of the light-emitting unit, and a gate of the seventh transistor is connected to the second reset signal terminal; and the storage circuit includes: a capacitor connected between the first node and the first power terminal.

According to one aspect of the present disclosure, a driving method of a pixel driving circuit is provided, applied to the pixel driving circuit as described above. The driving method includes: at a first light-emitting stage, using a first driving transistor to drive a light-emitting unit to emit light; and at a second light-emitting stage, using a current compensation circuit to drive the light-emitting unit to emit light.

According to one aspect of the present disclosure, a driving method of a pixel driving circuit is provided, applied to the pixel driving circuit as described above. The driving method includes: at a light-emitting stage, using simultaneously a first driving transistor and a current compensation circuit to drive a light-emitting unit to emit light.

According to one aspect of the present disclosure, a display panel is provided. The display panel includes the pixel driving circuit as described above.

According to one aspect of the present disclosure, a display apparatus is provided. The display apparatus includes the display panel as described above.

It should be understood that the general description in the above and the detailed description in the following are only illustrative and explanatory, and do not limit the present disclosure.

### BRIEF DESCRIPTION OF THE DRAWINGS

The drawings, which are incorporated in and constitute a part of this specification, illustrate embodiments consistent with the present disclosure and serve together with the specification to explain principles of the present disclosure. It is apparent that the drawings in the following description are only some embodiments of the present disclosure, and for those of ordinary skill in the art, other drawings can also be obtained from these drawings without creative efforts.

FIG. 1 is a schematic diagram of a structure of a pixel driving circuit according to embodiments of the present disclosure;

FIG. 2 is a schematic diagram of a structure of a pixel driving circuit according to embodiments of the present disclosure;

FIG. 3 is a schematic diagram of a structure of a pixel driving circuit according to embodiments of the present disclosure;

FIG. 4 is a schematic diagram of a structure of a pixel driving circuit according to embodiments of the present disclosure;

FIG. 5 is a schematic diagram of a structure of a pixel driving circuit according to embodiments of the present disclosure;

FIG. 6 is a schematic diagram of a structure of a pixel driving circuit according to embodiments of the present disclosure;

FIG. 7 is a schematic diagram of a structure of a pixel driving circuit according to embodiments of the present disclosure;

FIG. 8 is a schematic diagram of a structure of a pixel driving circuit according to embodiments of the present disclosure;

FIG. 9 is a schematic diagram of a structure of a pixel driving circuit according to embodiments of the present disclosure;

FIG. 10 is a timing diagram of each node in a driving method of the pixel driving circuit shown in FIG. 9 according to embodiments of the present disclosure;

FIG. 11 is a schematic diagram of a structure of a pixel driving circuit according to embodiments of the present disclosure;

FIG. 12 is a timing diagram of each node in a driving method of the pixel driving circuit shown in FIG. 11 according to embodiments of the present disclosure;

FIG. 13 is a schematic diagram of a structure of a pixel driving circuit according to embodiments of the present disclosure;

FIG. 14 is a timing diagram of each node in a driving method of the pixel driving circuit shown in FIG. 13 according to embodiments of the present disclosure;

FIG. 15 is a schematic diagram of a structure of a pixel driving circuit according to embodiments of the present disclosure; and

FIG. 16 is a schematic diagram of a structure of a pixel driving circuit according to embodiments of the present disclosure.

### DETAILED DESCRIPTION

Example embodiments will now be described more fully with reference to the drawings. Example embodiments, however, can be embodied in a variety of forms and should not be construed as being limited to examples set forth herein. Instead, these embodiments are provided so that the present disclosure will be thorough and complete, and will fully convey concepts of the example embodiments to those skilled in the art. The same reference numerals in the drawings represent the same or similar structures, and thus their detailed descriptions will be omitted.

Although relative terms such as “upper” and “lower” are used in this specification to describe a relative relationship of one component and another component, these terms are used in this specification only for convenience, for example, according to a direction of the example shown in the drawings. It will be appreciated that if the device illustrated is turned upside down, the component described as “upper” will become the “lower” component. Other relative terms, such as “high”, “low”, “top”, “bottom”, “left”, “right”, etc., also have similar meanings. When a certain structure is “on” another structure, it may mean that the certain structure is integrally formed on the other structure, or it may mean that the certain structure is “directly” arranged on the other structure, or that the certain structure is “indirectly” arranged on the other structure through yet another structure.

Terms “a”, “an”, and “the” are used to indicate presence of one or more elements/components/etc. Terms “include” and “comprise” are used to indicate an open-ended inclusion, and mean presence of additional elements/components/etc., in addition to listed elements/components/etc.

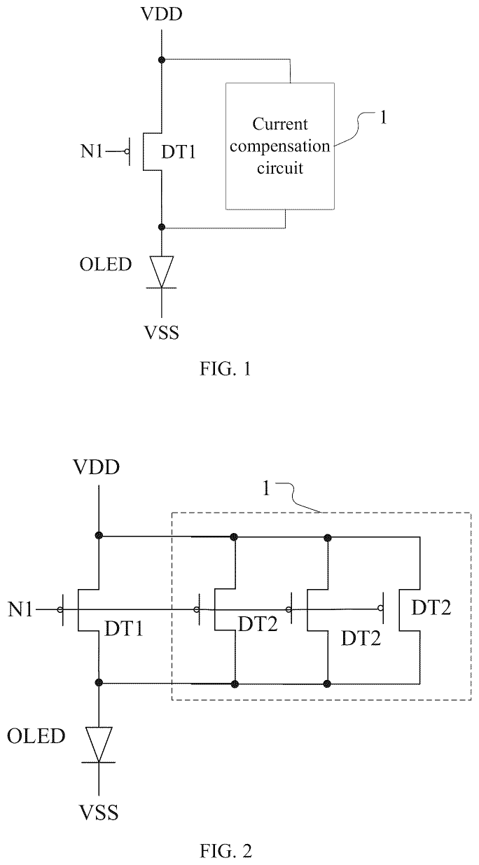

Embodiments of the present disclosure first provide a pixel driving circuit, as shown in FIG. 1, which is a schematic diagram of a structure of the pixel driving circuit according to embodiments of the present disclosure. The pixel driving circuit is configured to drive the light-emitting unit OLED to emit light. The pixel driving circuit can include a first driving transistor DT1 and a current compensation circuit 1. A first electrode of the first driving transistor DT1 is connected to a first power terminal VDD, a second electrode of the first driving transistor DT1 is connected to a first electrode of the light-emitting unit OLED, and a gate is connected to a first node N1. The current compensation circuit 1 is connected, in parallel with the first driving transistor DT1, between the first power terminal VDD and the first electrode of the light-emitting unit OLED. The current compensation circuit 1 is configured to provide, in response to a control signal, a driving current to the light-emitting unit OLED through the first power terminal VDD. In some embodiments, a second electrode of the light-emitting unit OLED can be connected to a second power terminal VSS. The first power terminal VDD can be a high-level signal terminal, and the second power terminal VSS can be a low-level signal terminal.

The pixel driving circuit provided in embodiments of the present disclosure can provide the driving current to the light-emitting unit through the current compensation circuit 1 and the first driving transistor DT1 simultaneously, or can provide the driving current to the light-emitting unit through the current compensation circuit 1 separately. Therefore, the upper limit of the output current of the pixel driving circuit will not be limited by the upper limit of the conduction current of the first driving transistor. The pixel driving circuit can output a larger current to better achieve the lifetime aging (L-Aging) process and/or the reverse aging process.

Embodiments of the present disclosure provide a pixel driving circuit, as shown in FIG. 2, which is a schematic diagram of another structure of the pixel driving circuit according to embodiments of the present disclosure. The current compensation circuit 1 can include one or more second driving transistors DT2 arranged in parallel. A first electrode of the second driving transistor DT2 is connected to the first electrode of the first driving transistor DT1, a second electrode of the second driving transistor DT2 is connected to the second electrode of the first driving transistor DT1, and a gate is connected to the first node N1. In some embodiments, the second driving transistor DT2 can be operated in the saturation region, and the second driving transistor DT2 can output, based on a voltage difference between the gate and the source, a preset current to the light-emitting unit OLED. The second driving transistor DT2 and the first driving transistor DT1 can have approximately the same width-length ratio of the channel region. In some embodiments, the width-length ratio of the channel region of the transistor A is A1, and the width-length ratio of the channel region of the transistor B is A2. In the present disclosure, the width-length ratio of the channel region of the transistor A and the width-length ratio of the channel region of the transistor B are approximately the same, which can be understood as |A1-A2 |/A2 being less than or equal to 10%.

It should be noted that in the pixel driving circuit shown in FIG. 2, the current compensation circuit 1 includes three second driving transistors DT2 arranged in parallel. It should be understood that in some other embodiments, the current compensation circuit 1 can also include another number of second driving transistors DT2. For example, the number of second driving transistors DT2 arranged in parallel in the current compensation circuit 1 can be 1, 2, 4, 8, etc.

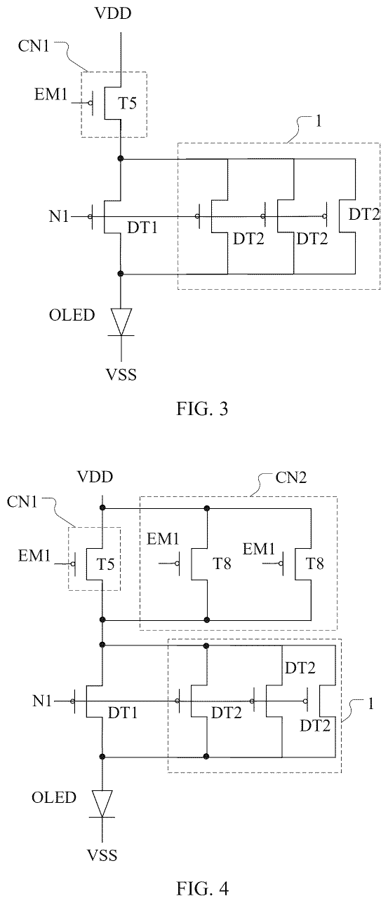

Embodiments of the present disclosure provide a pixel driving circuit, as shown in FIG. 3, which is a schematic diagram of another structure of the pixel driving circuit according to embodiments of the present disclosure. The pixel driving circuit can further include a first light-emitting control circuit CN1, which is connected to the first power terminal VDD and the first electrode of the first driving transistor DT1, and the first light-emitting control circuit CN1 is configured to connect, in response to a control signal, the first power terminal VDD and the first electrode of the first driving transistor DT1. In the embodiment, the upper limit of the conduction current of the first light-emitting control circuit CN1 may also limit the maximum output current of the pixel driving circuit.

As shown in FIG. 4, a schematic diagram of another structure of the pixel driving circuit according to embodiments of the present disclosure is provided. The current compensation circuit 1 can further include a second light-emitting control circuit CN2, which is connected to the first power terminal VDD and the first electrode of the first driving transistor DT1, and the second light-emitting control circuit CN2 is configured to connect, in response to a control signal, the first power terminal VDD and the first electrode of the first driving transistor DT1. According to the embodiment, the second light-emitting control circuit CN2 in parallel to the first light-emitting control circuit CN1 is added, thereby increasing the maximum output current of the pixel driving circuit. As shown in FIG. 4, the control terminals of the first light-emitting control circuit CN1 and the second light-emitting control circuit CN2 can both be connected to a first enabling signal terminal EM1, which means that the first light-emitting control circuit CN1 and the second light-emitting control circuit CN2 can be turned on simultaneously. It should be understood that in some other embodiments, the control terminals of the first light-emitting control circuit CN1 and the second light-emitting control circuit CN2 can also be connected to different signal terminals. When the lifetime aging is performed on the light-emitting unit, the second light-emitting control circuit CN2 can be turned on only.

As shown in FIG. 4, in some embodiments, the first light-emitting control circuit CN1 can include a fifth transistor T5. A first electrode of the fifth transistor T5 is connected to the first power terminal VDD, a second electrode of the fifth transistor T5 is connected to the first electrode of the first driving transistor DT1, and a gate is connected to the first enabling signal terminal EM1. The second light-emitting control circuit CN2 can include one or more parallel eighth transistors T8, with a first electrode of the eighth transistor T8 being connected to the first electrode of the fifth transistor T5, a second electrode of the eighth transistor T8 being connected to the second electrode of the fifth transistor T5, and a gate being connected to the first enabling signal terminal EM1.

It should be noted that in the pixel driving circuit shown in FIG. 4, the second light-emitting control circuit CN2 includes two parallel eighth transistors T8. It should be understood that in some other embodiments, the second light-emitting control circuit CN2 can include another number of eighth transistors T8. For example, the number of parallel eighth transistors T8 in the second light-emitting control circuit CN2 can be 1, 3, 4, 8, etc.

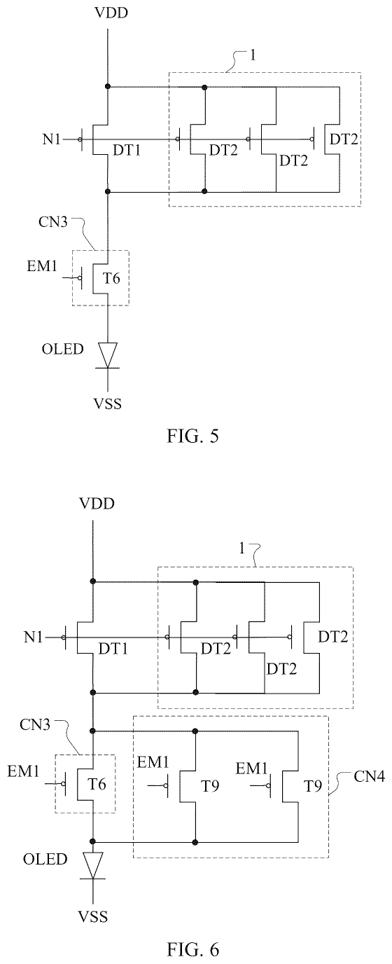

Embodiments of the present disclosure provide a pixel driving circuit, as shown in FIG. 5, which is a schematic diagram of another structure of the pixel driving circuit according to embodiments of the present disclosure. In some embodiments, the pixel driving circuit further includes a third light-emitting control circuit CN3, which is connected to the first electrode of the light-emitting unit OLED and the second electrode of the first driving transistor DT1, and the third light-emitting control circuit CN3 is configured to connect, in response to a control signal, the second electrode of the first driving transistor DT1 and the first electrode of the light-emitting unit OLED. In the embodiment, the upper limit of the conduction current of the third light-emitting control circuit CN3 may also limit the maximum output current of the pixel driving circuit.

As shown in FIG. 6, a schematic diagram of another structure of the pixel driving circuit according to embodiments of the present disclosure is provided. The current compensation circuit 1 further includes a fourth light-emitting control circuit CN4, which is connected to the first electrode of the light-emitting unit OLED and the second electrode of the first driving transistor DT1, and the fourth light-emitting control circuit CN4 is configured to connect, in response to a control signal, the second electrode of the first driving transistor DT1 and the first electrode of the light-emitting unit OLED. According to the embodiment, the fourth light-emitting control circuit CN4 in parallel to the third light-emitting control circuit CN3 is added, thereby increasing the maximum output current of the pixel driving circuit. As shown in FIG. 6, the control terminals of the third light-emitting control circuit CN3 and the fourth light-emitting control circuit CN4 can be both connected to the enabling signal terminal EM1, which means that the third light-emitting control circuit CN3 and the fourth light-emitting control circuit CN4 can be turned on simultaneously. It should be understood that in some other embodiments, the control terminals of the third light-emitting control circuit CN3 and the fourth light-emitting control circuit CN4 can also be connected to different signal terminals. When the lifetime aging is performed on the light-emitting unit, the fourth light-emitting control circuit CN4 can be turned on only.

As shown in FIG. 6, the third light-emitting control circuit CN3 can include a sixth transistor T6. A first electrode of the sixth transistor T6 is connected to the second electrode of the first driving transistor DT1, a second electrode of the sixth transistor T6 is connected to the first electrode of the light-emitting unit OLED, and a gate is connected to the first enabling signal terminal EM1. The fourth light-emitting control circuit CN4 can include one or more parallel ninth transistors T9, with a first electrode of the ninth transistor T9 being connected to the first electrode of the sixth transistor T6, a second electrode of the ninth transistor T9 being connected to the second electrode of the sixth transistor T6, and a gate being connected to the first enabling signal terminal EM1.

It should be noted that in the pixel driving circuit shown in FIG. 6, the fourth light-emitting control circuit CN4 includes two parallel ninth transistors T9. It should be understood that in some other embodiments, the fourth light-emitting control circuit CN4 can also include another number of ninth transistors T9. For example, the number of parallel ninth transistors T9 in the fourth light-emitting control circuit CN4 can be 1, 3, 4, 8, etc.

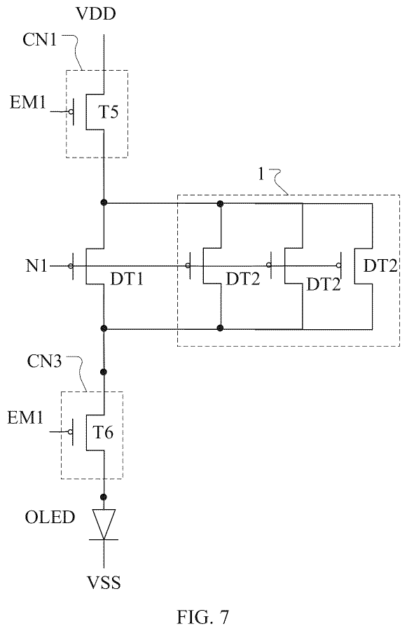

As shown in FIG. 7, a schematic diagram of another structure of the pixel driving circuit according to embodiments of the present disclosure is provided. The pixel driving circuit can further include a first light-emitting control circuit CN1 and a third light-emitting control circuit CN3. The first light-emitting control circuit CN1 is connected to the first power terminal VDD and the first electrode of the first driving transistor DT1, and is configured connect, in response to a control signal, the first power terminal VDD and the first electrode of the first driving transistor DT1. The third light-emitting control circuit CN3 is connected to the first electrode of the light-emitting unit OLED and the second electrode of the first driving transistor DT1, and is configured to connect, in response to a control signal, the second electrode of the first driving transistor DT1 and the first electrode of the light-emitting unit OLED. The upper limit of the conduction currents of the first light-emitting control circuit CN1 and the third light-emitting control circuit CN3 will both affect the maximum output current of the pixel driving circuit.

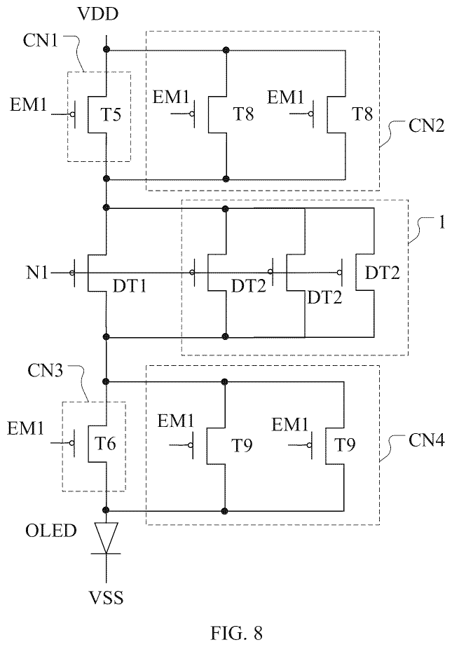

As shown in FIG. 8, a schematic diagram of another structure of the pixel driving circuit according to embodiments of the present disclosure is provided. The current compensation circuit 1 can further include a second light-emitting control circuit CN2 and a fourth light-emitting control circuit CN4. The second light-emitting control circuit CN2 is connected to the first power terminal VDD and the first electrode of the first driving transistor DT1, and the second light-emitting control circuit CN2 is configured to connect, in response to a control signal, the first power terminal VDD and the first electrode of the first driving transistor DT1. The fourth light-emitting control circuit CN4 is connected to the first electrode of the light-emitting unit OLED and the second electrode of the first driving transistor DT1, and the fourth light-emitting control circuit CN4 is configured to connect, in response to a control signal, the second electrode of the first driving transistor DT1 and the first electrode of the light-emitting unit OLED. According to the embodiment, the second light-emitting control circuit CN2 arranged in parallel to the first light-emitting control circuit CN1, and the fourth light-emitting control circuit CN4 arranged in parallel to the third light-emitting control circuit CN3, are added, thereby increasing the maximum output current of the pixel driving circuit. The structures of the second light-emitting control circuit CN2 and the fourth light-emitting control circuit CN4 can be the same as those in the above embodiments.

In some embodiments of the present disclosure, the first driving transistor DT1 and the second driving transistor DT2, serving as driving transistors, need to be operated in the saturation region, while the fifth transistor T5, the sixth transistor T6, the eighth transistor T8, and the ninth transistor T9, serving as switching transistors, are operated in the cut-off region and the saturation region. The width-length ratio of the channel region of the driving transistor needs to be smaller than the width-length ratio of the channel region of the switching transistor. Meanwhile, due to the fact that the upper limit of the current when the transistor is turned on is positively correlated to the width-length ratio of the channel region of the transistor. Therefore, in some embodiments, the number of parallel eighth transistors T8 can be smaller than the number of parallel second driving transistors DT2, and the number of parallel ninth transistors T9 can be smaller than the number of parallel second driving transistors DT2. For example, the number of eighth transistors T8 is m1, the number of second driving transistors DT2 is m2, and the number of ninth transistors T9 is m3, then (m1+1):(m2+1):(m3+1) can be equal to 1:4:1.

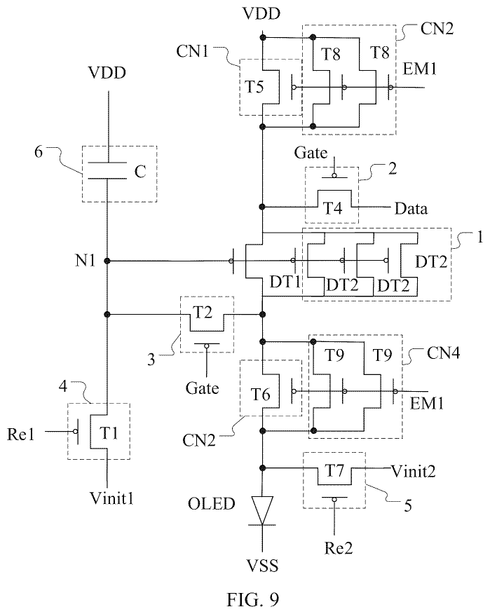

In some embodiments, the parallel transistor scheme described above can be applied to pixel driving circuits of various architectures. For example, the above-mentioned parallel transistor scheme can be applied to the 7T1C pixel driving circuit, as shown in FIG. 9, which is a schematic diagram of another structure of the pixel driving circuit according to embodiments of the present disclosure. In the embodiment, the pixel driving circuit further includes a data writing circuit 2, a first light-emitting control circuit CN1, a third light-emitting control circuit CN3, a compensation circuit 3, a first reset circuit 4, a second reset circuit 5, and a storage circuit 6. The data writing circuit 2 is connected to the first electrode of the first driving transistor DT1, a data signal terminal Data, and a gate driving signal terminal Gate, and the data writing circuit 2 is configured to transmit, in response to the signal on the gate driving signal terminal Gate, the signal on the data signal terminal Data to the first electrode of the first driving transistor DT1. The first light-emitting control circuit CN1 is connected to the first power terminal VDD, the first electrode of the first driving transistor DT1, and the first enabling signal terminal EM1, and the first light-emitting control circuit CN1 is configured to connect, in response to the signal on the first enabling signal terminal EM1, the first power terminal VDD and the first electrode of the first driving transistor DT1. The third light-emitting control circuit CN3 is connected to the first electrode of the light-emitting unit OLED, the second electrode of the first driving transistor DT1, and the first enabling signal terminal EM1, and the third light-emitting control circuit CN3 is configured to connect, in response to the signal on the first enabling signal terminal EM1, the second electrode of the first driving transistor DT1 and the first electrode of the light-emitting unit OLED. The compensation circuit 3 is connected to the first node N1, the second electrode of the first driving transistor DT1, and the gate driving signal terminal Gate, and the compensation circuit 3 is configured to connect, in response to the signal on the gate driving signal terminal Gate, the first node N1 and the second electrode of the first driving transistor DT1. The first reset circuit 4 is connected to a first initial signal terminal Vinit1, the first node N1, and a first reset signal terminal Rel, and the first reset circuit 4 is configured to transmit, in response to the signal on the first reset signal terminal Rel, the signal on the first initial signal terminal Vinit1 to the first node N1. The second reset circuit 5 is connected to the first electrode of the light-emitting unit OLED, a second initial signal terminal Vinit2, and a second reset signal terminal Re2, and the second reset circuit 5 is configured to transmit, in response to the signal on the second reset signal terminal Re2, the signal on the second initial signal terminal Vinit2 to the first electrode of the light-emitting unit OLED. The storage circuit 6 is connected between the first node N1 and the first power terminal VDD.

In some embodiments, as shown in FIG. 9, the data writing circuit 2 includes a fourth transistor T4. A first electrode of the fourth transistor T4 is connected to the data signal terminal Data, a second electrode of the fourth transistor T4 is connected to the first electrode of the first driving transistor DT1, and a gate is connected to the gate driving signal terminal Gate. The first light-emitting control circuit CN1 includes a fifth transistor T5. A first electrode of the fifth transistor T5 is connected to the first power terminal VDD, a second electrode of the fifth transistor T5 is connected to the first electrode of the first driving transistor DT1, and a gate is connected to the first enabling signal terminal EM1. The third light-emitting control circuit CN3 includes a sixth transistor T6. A first electrode of the sixth transistor T6 is connected to the second electrode of the first driving transistor DT1, a second electrode of the sixth transistor T6 is connected to the first electrode of the light-emitting unit OLED, and a gate is connected to the first enabling signal terminal EM1. The compensation circuit includes a second transistor T2. A first electrode of the second transistor T2 is connected to the first node N1, a second electrode of the second transistor T2 is connected to the second electrode of the first driving transistor DT1, and a gate is connected to the gate driving signal terminal Gate. The first reset circuit 4 includes a first transistor T1. A first electrode of the first transistor T1 is connected to the first initial signal terminal Vinit1, a second electrode of the first transistor T1 is connected to the first node N1, and a gate is connected to the first reset signal terminal Rel. The second reset circuit 5 includes a seventh transistor T7. A first electrode of the seventh transistor T7 is connected to the second initial signal terminal Vinit2, a second electrode of the seventh transistor T7 is connected to the first electrode of the light-emitting unit OLED, and a gate is connected to the second reset signal terminal Re2. The storage circuit 6 includes a capacitor C, which is connected between the first node N1 and the first power terminal VDD.

In some other embodiments, the first reset signal terminal Re1 and the second reset signal terminal Re2 can share the same signal terminal, and the first initial signal terminal Vinit1 and the second initial signal terminal Vinit1 can also share the same signal terminal.

In some embodiments, the first transistor T1, the second transistor T2, the fourth transistor T4, the fifth transistor T5, the sixth transistor T6, the seventh transistor T7, the eighth transistor T8, the ninth transistor T9, the first driving transistor DT1, and the second driving transistor DT2 can all be P-type transistors. The threshold voltage of the first driving transistor DT1 and the threshold voltage of the second driving transistor DT2 can be the same.

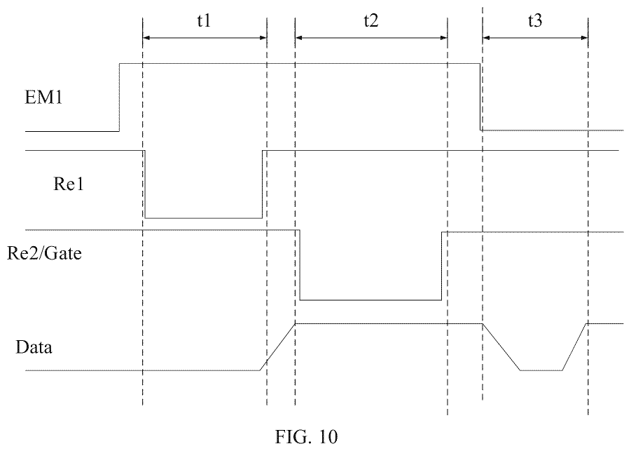

As shown in FIG. 10, a timing diagram of each node in a driving method of the pixel driving circuit shown in FIG. 9 according to embodiments of the present disclosure is provided. In some embodiments, ‘Gate’ represents the timing of the signal on the gate driving signal terminal, ‘Re1’ represents the timing of the signal on the first reset signal terminal, ‘Re2’ represents the timing of the signal on the second reset signal terminal, ‘EM1’ represents the timing of the signal on the first enabling signal terminal EM1, and ‘Data’ represents the timing of the signal on the data signal terminal. The driving method of the pixel driving circuit in the display panel can include a reset stage t1, a data writing stage t2, and a light-emitting stage t3. At the reset stage t1, the first reset signal terminal Re1 outputs a low-level signal, the first transistor T1 is turned on, and the first initial signal terminal Vinitl inputs a first initial signal to the first node N1. At the data writing stage t2, the gate driving signal terminal Gate outputs a low-level signal, the fourth transistor T4, the second transistor T2, and the seventh transistor T7 are turned on, the data signal terminal Data outputs a data signal to write a voltage Vdata+Vth to the first node N1, where Vdata is the voltage of the data signal, Vth is the threshold voltage of the first driving transistor DT1, and at the same time, the second initial signal terminal Vinit2 inputs a second initial signal to the second electrode of the sixth transistor T6. At the light-emitting stage t3, the first enabling signal terminal EM1 outputs a low-level signal, the sixth transistor T6, the eighth transistor T8, the fifth transistor T5, and the ninth transistor T9 are turned on, and the first driving transistor DT1 and the second driving transistor DT2 drive the light-emitting unit to emit light under the voltage Vdata+Vth of the first node N1. Any driving transistor (including any first driving transistor or second driving transistor) outputs a driving current I=(μ WCox/2L) (Vdata+Vth-Vdd-Vth)², where μ is the carrier mobility, Cox is the gate capacitance per unit area, W is the width of the channel of the driving transistor, L is the length of the channel of the driving transistor, Vgs is the voltage difference between the gate and the source of the driving transistor, and Vth is the threshold voltage of the driving transistor. The total current output by the pixel driving circuit is equal to a sum of currents output from each driving transistor.

It should be understood that in some other embodiments, the pixel driving circuit shown in FIG. 9 may not include the ninth transistor T9 and/or the eighth transistor T8. The threshold voltage of the first driving transistor DT1 and the threshold voltage of the second driving transistor DT2 may also be different.

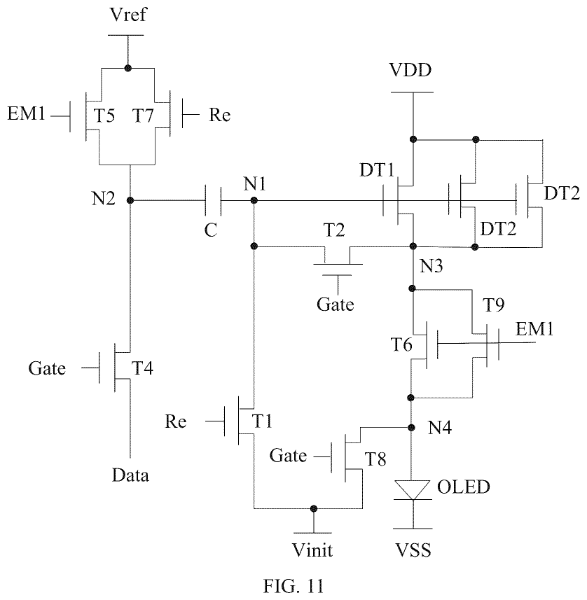

It should be understood that the above parallel transistor scheme can also be applied to pixel driving circuits of other architectures. As shown in FIG. 11, a schematic diagram of another structure of the pixel driving circuit according to embodiments of the present disclosure is provided. The pixel driving circuit includes a first transistor T1, a second transistor T2, a fourth transistor T4, a fifth transistor T5, a sixth transistor T6, a seventh transistor T7, an eighth transistor T8, a ninth transistor T9, a first driving transistor DT1, a second driving transistor DT2, and a capacitor C. In some embodiments, the first transistor T1, the second transistor T2, the fourth transistor T4, the fifth transistor T5, the sixth transistor T6, the seventh transistor T7, the eighth transistor T8, the ninth transistor T9, the first driving transistor DT1, and the second driving transistor DT2 can all be P-type transistors. The threshold voltage of the first driving transistor DT1 and the threshold voltage of the second driving transistor DT2 can be the same.

It should be understood that in some other embodiments, the pixel driving circuit shown in FIG. 11 may not include the ninth transistor T9. The threshold voltage of the first driving transistor DT1 and the threshold voltage of the second driving transistor DT2 may also be different.

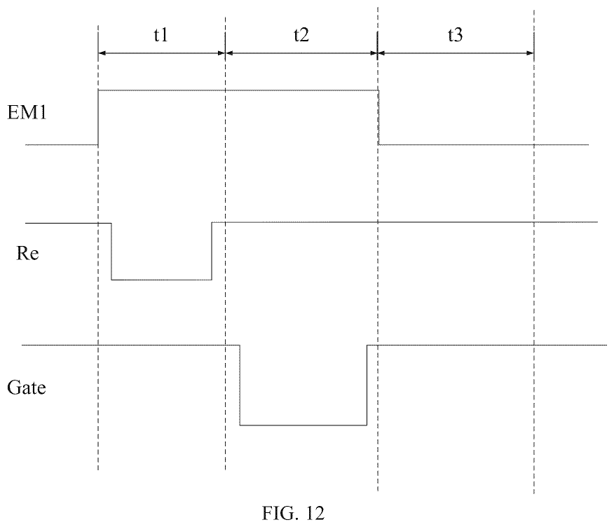

As shown in FIG. 12, a timing diagram of each node in a driving method of the pixel driving circuit shown in FIG. 11 according to embodiments of the present disclosure is provided. In some embodiments, ‘Gate’ represents the timing of the signal on the gate driving signal terminal Gate, ‘Re’ represents the timing of the signal on the reset signal terminal Re, and ‘EM1’ represents the timing of the signal on the first enabling signal terminal EM1. The driving method of the pixel driving circuit in the display panel can include a reset stage t1, a data writing stage t2, and a light-emitting stage t3. At the reset stage t1, the reset signal terminal Re outputs a low-level signal, the first transistor T1 and the seventh transistor T7 are turned on, the reference voltage terminal Vref inputs a reference voltage Vf to the second node N2, and the initial signal terminal Vinit inputs an initial voltage Vt to the first node N1. At the data writing stage t2, the gate driving signal terminal Gate outputs a low-level signal, the fourth transistor T4, the second transistor T2, and the eighth transistor T8 are turned on, and the data signal terminal Data inputs a data signal to the second node N2. The voltage of the data signal is Vdata, and the voltage of the second node N2 changes from Vf to Vdata. Under the coupling of the capacitor C, the voltage of the first node N1 changes from Vt to Vt+Vdata-Vf, the first driving transistor DT1 and the second driving transistor DT2 are turned on, and the first power terminal VDD inputs a voltage of Vdd+Vth to the first node N1, where Vdd is the voltage of the first power terminal VDD and Vth is the threshold voltage of the first driving transistor DT1. At the light-emitting stage t3, the first enabling signal terminal EM1 outputs a low-level signal, the fifth transistor T5, the sixth transistor T6, and the ninth transistor T9 are turned on, the voltage of the second node N2 changes from Vdata to Vf, and under the coupling of the capacitor C, the voltage of the first node N1 changes to Vdd+Vth+Vf-Vdata. The first driving transistor DT1 and the second driving transistor DT2 output driving currents under the voltage of the first node N1, to drive the light-emitting unit OLED to emit light.

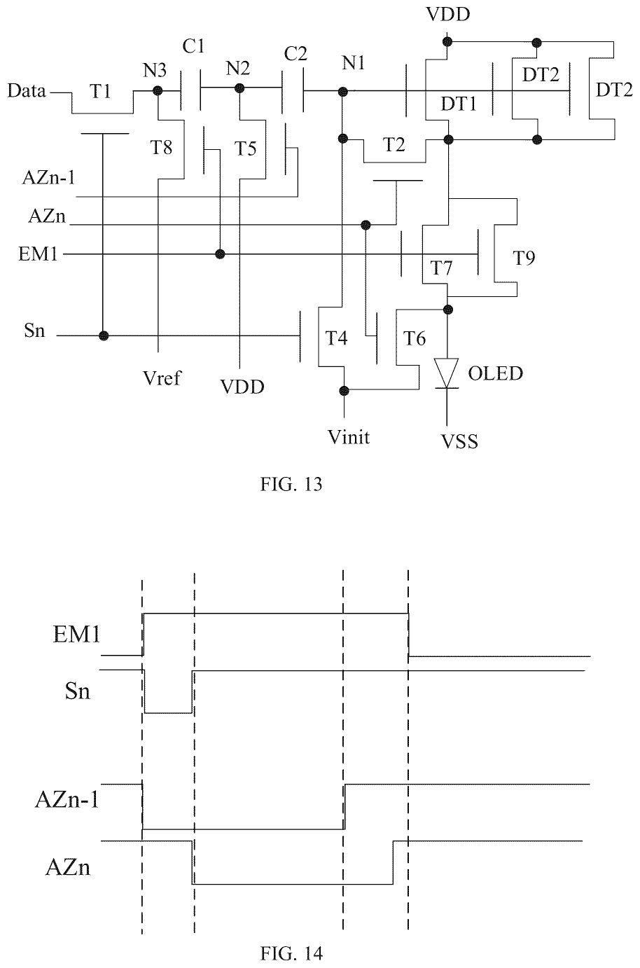

As shown in FIG. 13, a schematic diagram of another structure of the pixel driving circuit according to embodiments of the present disclosure is provided. The pixel driving circuit includes a first transistor T1, a second transistor T2, a fourth transistor T4, a fifth transistor T5, a sixth transistor T6, a seventh transistor T7, an eighth transistor T8, a ninth transistor T9, a first driving transistor DT1, a second driving transistor DT2, a first capacitor C1, and a second capacitor C2. In some embodiments, the first transistor T1, the second transistor T2, the fourth transistor T4, the fifth transistor T5, the sixth transistor T6, the seventh transistor T7, the eighth transistor T8, the ninth transistor T9, the first driving transistor DT1, and the second driving transistor DT2 can all be P-type transistors. The threshold voltage of the first driving transistor DT1 and the threshold voltage of the second driving transistor DT2 may be the same.

It should be understood that in some other embodiments, the pixel driving circuit shown in FIG. 13 may not include the ninth transistor T9. The threshold voltage of the first driving transistor DT1 and the threshold voltage of the second driving transistor DT2 may also be different.

As shown in FIG. 14, a timing diagram of each node in a driving method of the pixel driving circuit shown in FIG. 13 according to embodiments of the present disclosure is provided. In some embodiments, ‘AZn-1’ represents the timing of the signal on the first control signal terminal AZn-1, ‘AZn’ represents the timing of the signal on the second control signal terminal AZn, ‘EM1’ represents the timing of the signal on the first enabling signal terminal EM1, and ‘Sn’ represents the timing of the signal on the third control signal terminal Sn. The driving method of the pixel driving circuit in the display panel can include a first stage t1, a second stage t2, and a third stage t3. At the first stage t1, the third control signal terminal Sn and the first control signal terminal AZn-1 output low-level signals, the first transistor T1, the fourth transistor T4, and the fifth transistor T5 are turned on, and the data signal terminal Data inputs a data signal to the third node N3. The voltage of the data signal is Vdata. The first power terminal VDD inputs a high-level power supply voltage Vdd to the second node N2, and the initial signal terminal Vinit inputs an initial voltage Vt to the first node N1. At the second stage t2, the first control signal terminal AZn-1 and the second control signal terminal AZn output low-level signals, the fifth transistor T5, the second transistor T2, and the sixth transistor T6 are turned on, and the initial signal terminal Vinit inputs the initial signal to the first electrode of the light-emitting unit OLED. At the same time, the first power terminal VDD inputs a voltage of Vdd+Vth to the first node N1, where Vdd is the voltage of the first power terminal and Vth is the threshold voltage of the first driving transistor DT1. At the third stage t3, the first enabling signal terminal EM1 outputs a low-level signal, the eighth transistor T8, the seventh transistor T7, and the ninth transistor T9 are turned on, and the voltage of the third node N3 changes from Vdata to Vf, where Vf is the voltage of the reference voltage terminal Vref. Under the coupling of the first capacitor C1 and the second capacitor C2, the voltage of the first node N1 changes to Vdd+Vth+Vf-Vdata. At the same time, the first driving transistor DT1 and the second driving transistor DT2 output currents under the action of the first node N1, to drive the light-emitting unit OLED to emit light.

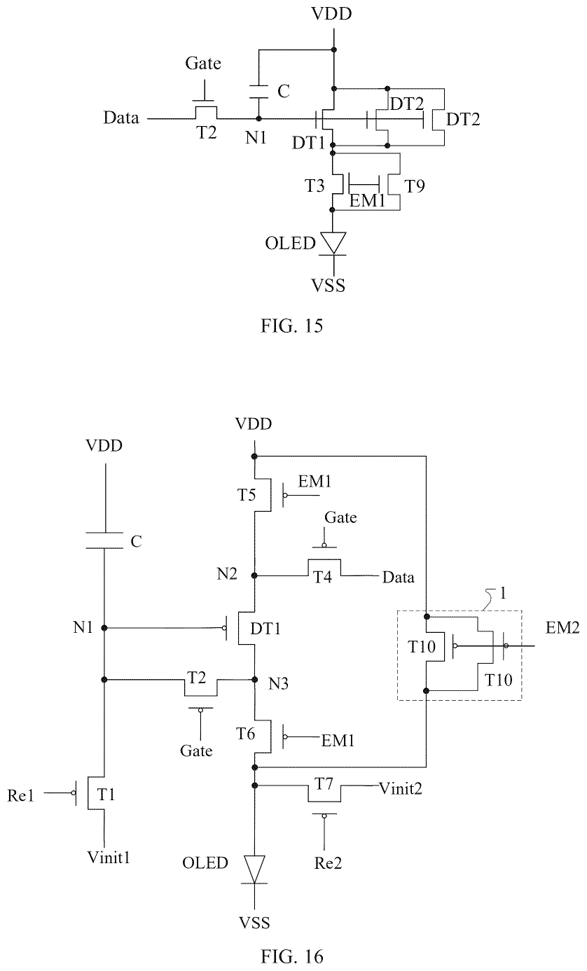

As shown in FIG. 15, a schematic diagram of another structure of the pixel driving circuit according to embodiments of the present disclosure is provided. The pixel driving circuit includes a second transistor T2, a third transistor T3, a ninth transistor T9, a first driving transistor DT1, a second driving transistor DT2, and a capacitor C. In some embodiments, the second transistor T2, the third transistor T3, the ninth transistor T9, the first driving transistor DT1, and the second driving transistor DT2 can all be P-type transistors. The driving method of the pixel driving circuit can include a data writing stage and a light-emitting stage. At the data writing stage, the gate driving signal terminal Gate outputs a low-level signal, the second transistor T2 is turned on, and the data signal terminal Data writes the data signal to the first node N1. At the light-emitting stage, the first enabling signal terminal EM1 outputs a low-level signal, the third transistor T3 and the ninth transistor T9 are turned on, and the first driving transistor DT1 and the second driving transistor DT2 input driving currents to the light-emitting unit OLED under the action of the first node N1.

It should be understood that in some other embodiments, the pixel driving circuit shown in FIG. 15 may not include the ninth transistor T9. The threshold voltage of the first driving transistor DT1 and the threshold voltage of the second driving transistor DT2 may also be different.

As shown in FIG. 16, a schematic diagram of another structure of the pixel driving circuit according to embodiments of the present disclosure is provided. The current compensation circuit 1 can include one or more parallel tenth transistors T10. A first electrode of the tenth transistor T10 is connected to the first power terminal VDD, a second electrode of the tenth transistor T10 is connected to the first electrode of the light-emitting unit OLED, and a gate is connected to the second enabling signal terminal EM2.

The pixel driving circuit provided in the embodiment adds a tenth transistor T10 on the basis of the pixel driving circuit of the 7T1C architecture. When the display panel is driven normally, the tenth transistor T10 is turned off, and the timing of each control signal in the 7T1C pixel driving circuit can be as shown in FIG. 10, where the display panel is driven normally. When the display panel needs to undergo aging treatment, all transistors in the 7T1C pixel driving circuit are turned off, the tenth transistor T10 is turned on, and the first power terminal VDD provides the driving current to the light-emitting unit OLED through the tenth transistor T10. In some embodiments, the width-length ratio of the channel region of the tenth transistor T10 can be greater than the width-length ratio of the channel region of the first driving transistor DT1. That is, the tenth transistor T10 can provide a larger driving current to the light-emitting unit OLED.

It should be noted that the pixel driving circuit shown in FIG. 16 includes two tenth transistors T10. It should be understood that in some other embodiments, the number of tenth transistors T10 can also be other values, such as 1, 3, 5, 8, etc.

It should be understood that in some other embodiments, when the display panel needs to be aged, the tenth transistor T10 and the first driving transistor DT1 can also be turned on simultaneously, and the first power terminal VDD can provide the driving current to the light-emitting unit OLED through the tenth transistor T10 and the first driving transistor DT1 simultaneously. In addition, in some other embodiments, the method in which the tenth transistor T10 is added can also be applied to pixel driving circuits of any other architectures. The effect of increasing the maximum output current of the pixel driving circuit can be achieved, as long as the first electrode of the tenth transistor T10 is directly connected to the first power terminal and the second electrode of the tenth transistor T10 is directly connected to the light-emitting unit. Meanwhile, the scheme in which a second driving transistor, a second light-emitting control circuit, a fourth light-emitting control circuit, and a tenth transistor are added can also be applied to the same pixel driving circuit.

According to one aspect of the present disclosure, a display panel including the pixel driving circuit described above is also provided.

Embodiments of the present disclosure also provide a display apparatus including the display panel described above. The display apparatus can be a mobile phone, a tablet computer, a TV, or other display apparatuses.

After considering the specification and practicing of the invention disclosed herein, those skilled in the art will easily come up with other implementation solutions of the present disclosure. The present disclosure aims to cover any variations, uses, or adaptive changes of the present disclosure, which follow the general principles of the present disclosure and include common knowledge or commonly used technical means in the art that are not disclosed in the present disclosure. The specification and embodiments are only considered exemplary, and the true scope and spirit of the present disclosure are defined by appended claims.

The drawings in the present disclosure only relate to the structures involved in the present disclosure, and other structures can refer to conventional designs. In the absence of conflicts, embodiments and the features in the embodiments can be combined with each other to obtain new embodiments. Those skilled in the art should understand that modifications or equivalent substitutions can be made to embodiments of the present disclosure without departing from the spirit and scope of the present disclosure, which should be included in the scope of the claims of the present disclosure.

It should be understood that the present disclosure is not limited to the precise structures described above and shown in the drawings, and various modifications and changes can be made without departing from the scope of the present disclosure, and the scope of the present disclosure is limited only by the appended claims.

1. A pixel driving circuit, configured to drive a light-emitting unit to emit light, comprising:
a first driving transistor, wherein a first electrode of the first driving transistor is connected to a first power terminal, a second electrode of the first driving transistor is connected to a first electrode of the light-emitting unit, and a gate of the first driving transistor is connected to a first node; and
a current compensation circuit, wherein the current compensation circuit is connected in parallel to the first driving transistor between the first power terminal and the first electrode of the light-emitting unit, and is configured to provide, in response to a first control signal, a driving current to the light-emitting unit through the first power terminal.

2. The pixel driving circuit according to claim 1, wherein the current compensation circuit comprises:
one or more parallel second driving transistors, wherein a first electrode of each second driving transistor is connected to the first electrode of the first driving transistor, a second electrode of each second driving transistor is connected to the second electrode of the first driving transistor, and a gate of each second driving transistor is connected to the first node.

3. The pixel driving circuit according to claim 2, further comprising:
a first light-emitting control circuit, wherein the first light-emitting control circuit is connected to the first power terminal and the first electrode of the first driving transistor, and is configured to connect, in response to a second control signal, the first power terminal and the first electrode of the first driving transistor; and
wherein the current compensation circuit further comprises:
a second light-emitting control circuit, wherein the second light-emitting control circuit is connected to the first power terminal and the first electrode of the first driving transistor, and is configured to connect, in response to a third control signal, the first power terminal and the first electrode of the first driving transistor.

4. The pixel driving circuit according to claim 3, further comprising:
a third light-emitting control circuit, wherein the third light-emitting control circuit is connected to the first electrode of the light-emitting unit and the second electrode of the first driving transistor, and is configured to connect, in response to a fourth control signal, the second electrode of the first driving transistor and the first electrode of the light-emitting unit; and
wherein the current compensation circuit further comprises:
a fourth light-emitting control circuit, wherein the fourth light-emitting control circuit is connected to the first electrode of the light-emitting unit and the second electrode of the first driving transistor, and is configured to connect, in response to a fifth control signal, the second electrode of the first driving transistor and the first electrode of the light-emitting unit.

5. The pixel driving circuit according to claim 4, wherein the pixel driving circuit further comprises the first light-emitting control circuit and the third light-emitting control circuit, and the current compensation circuit further comprises the second light-emitting control circuit and the fourth light-emitting control circuit;
the first light-emitting control circuit is further connected to a first enabling signal terminal, and is configured to connect, in response to a signal on the first enabling signal terminal, the first power terminal and the first electrode of the first driving transistor;
the second light-emitting control circuit is further connected to the first enabling signal terminal, and is configured to connect, in response to the signal on the first enabling signal terminal, the first power terminal and the first electrode of the first driving transistor;
the third light-emitting control circuit is further connected to the first enabling signal terminal, and is configured to connect, in response to the signal on the first enabling signal terminal, the second electrode of the first driving transistor and the first electrode of the light-emitting unit; and
the fourth light-emitting control circuit is further connected to the first enabling signal terminal, and is configured to connect, in response to the signal on the first enabling signal terminal, the second electrode of the first driving transistor and the first electrode of the light-emitting unit.

6. The pixel driving circuit according to claim 5, wherein
the first light-emitting control circuit comprises:
a fifth transistor, wherein a first electrode of the fifth transistor is connected to the first power terminal, a second electrode of the fifth transistor is connected to the first electrode of the first driving transistor, and a gate of the fifth transistor is connected to the first enabling signal terminal;
the second light-emitting control circuit comprises:
one or more parallel eighth transistors, wherein a first electrode of each eighth transistor is connected to the first electrode of the fifth transistor, a second electrode of each eighth transistor is connected to the second electrode of the fifth transistor, and a gate of each eighth transistor is connected to the first enabling signal terminal;
the third light-emitting control circuit comprises:
a sixth transistor, wherein a first electrode of the sixth transistor is connected to the second electrode of the first driving transistor, a second electrode of the sixth transistor is connected to the first electrode of the light-emitting unit, and a gate of the sixth transistor is connected to the first enabling signal terminal;
and the fourth light-emitting control circuit comprises:
one or more parallel ninth transistors, wherein a first electrode of each ninth transistor is connected to the first electrode of the sixth transistor, a second electrode of each ninth transistor is connected to the second electrode of the sixth transistor, and a gate of each ninth transistor is connected to the first enabling signal terminal.

7. The pixel driving circuit according to claim 6, wherein width-length ratios of channel regions of the fifth transistor, the sixth transistor, the eighth transistor, and the ninth transistor are approximately the same, and width-length ratios of channel regions of the first driving transistor and the second driving transistor are approximately the same; and
wherein the width-length ratio of the channel region of any one of the fifth transistor, the sixth transistor, the eighth transistor, and the ninth transistor is greater than the width-length ratio of the channel region of any one of the first driving transistor and the second driving transistor.

8. The pixel driving circuit according to claim 1, wherein the current compensation circuit comprises:
one or more parallel tenth transistors, wherein a first electrode of each tenth transistor is connected to the first power terminal, a second electrode of each tenth transistor is connected to the first electrode of the light-emitting unit, and a gate of each tenth transistor is connected to a second enabling signal terminal.

9. The pixel driving circuit according to claim 8, wherein a width-length ratio of a channel region of the tenth transistor is greater than a width-length ratio of a channel region of the first driving transistor.

10. The pixel driving circuit according to claim 1, further comprising:
a data writing circuit connected to the first electrode of the first driving transistor, a data signal terminal, and a gate driving signal terminal, and configured to transmit, in response to a signal on the gate driving signal terminal, a signal on the data signal terminal to the first electrode of the first driving transistor;
a first light-emitting control circuit connected to the first power terminal, the first electrode of the first driving transistor, and a first enabling signal terminal, and configured to connect, in response to a signal on the first enabling signal terminal, the first power terminal and the first electrode of the first driving transistor;
a third light-emitting control circuit connected to the first electrode of the light-emitting unit, the second electrode of the first driving transistor, and the first enabling signal terminal, and configured to connect, in response to the signal on the first enabling signal terminal, the second electrode of the first driving transistor and the first electrode of the light-emitting unit;
a compensation circuit connected to the first node, the second electrode of the first driving transistor, and the gate driving signal terminal, and configured to connect, in response to the signal on the gate driving signal terminal, the first node and the second electrode of the first driving transistor;
a first reset circuit connected to a first initial signal terminal, the first node, and a first reset signal terminal, and configured to transmit, in response to a signal on the first reset signal terminal, a signal on the first initial signal terminal to the first node;
a second reset circuit connected to the first electrode of the light-emitting unit, a second initial signal terminal, and a second reset signal terminal, and configured to transmit, in response to a signal on the second reset signal terminal, a signal on the second initial signal terminal to the first electrode; and
a storage circuit connected between the first node and the first power terminal.

11. The pixel driving circuit according to claim 10, wherein
the data writing circuit comprises:
a fourth transistor, wherein a first electrode of the fourth transistor is connected to the data signal terminal, a second electrode of the fourth transistor is connected to the first electrode of the first driving transistor, and a gate of the fourth transistor is connected to the gate driving signal terminal;
the first light-emitting control circuit comprises:
a fifth transistor, wherein a first electrode of the fifth transistor is connected to the first power terminal, a second electrode of the fifth transistor is connected to the first electrode of the first driving transistor, and a gate of the fifth transistor is connected to the first enabling signal terminal;
the third light-emitting control circuit comprises:
a sixth transistor, wherein a first electrode of the sixth transistor is connected to the second electrode of the first driving transistor, a second electrode of the sixth transistor is connected to the first electrode of the light-emitting unit, and a gate of the sixth transistor is connected to the first enabling signal terminal;
the compensation circuit comprises:
a second transistor, wherein a first electrode of the second transistor is connected to the first node, a second electrode of the second transistor is connected to the second electrode of the first driving transistor, and a gate of the second transistor is connected to the gate driving signal terminal;
the first reset circuit comprises:
a first transistor, wherein a first electrode of the first transistor is connected to the first initial signal terminal, a second electrode of the first transistor is connected to the first node, and a gate of the first transistor is connected to the first reset signal terminal;
the second reset circuit comprises:
a seventh transistor, wherein a first electrode of the seventh transistor is connected to the second initial signal terminal, a second electrode of the seventh transistor is connected to the first electrode of the light-emitting unit, and a gate of the seventh transistor is connected to the second reset signal terminal;
and the storage circuit comprises:
a capacitor connected between the first node and the first power terminal.

12. A driving method of a pixel driving circuit according to claim 1, the method comprising:
at a first light-emitting stage, using a first driving transistor to drive a light-emitting unit to emit light; and
at a second light-emitting stage, using a current compensation circuit to drive the light-emitting unit to emit light.

13. A driving method of a pixel driving circuit according to claim 1, the method comprising:
at a light-emitting stage, using simultaneously a first driving transistor and a current compensation circuit to drive a light-emitting unit to emit light.

14. A display panel, comprising a pixel driving circuit, wherein the pixel driving circuit comprises:
a first driving transistor, wherein a first electrode of the first driving transistor is connected to a first power terminal, a second electrode of the first driving transistor is connected to a first electrode of the light-emitting unit, and a gate of the first driving transistor is connected to a first node; and
a current compensation circuit, wherein the current compensation circuit is connected in parallel to the first driving transistor between the first power terminal and the first electrode of the light-emitting unit, and is configured to provide, in response to a first control signal, a driving current to the light-emitting unit through the first power terminal.

15. A display device, comprising a display panel, wherein the display panel comprises a pixel driving circuit, and the pixel driving circuit comprises:
a first driving transistor, wherein a first electrode of the first driving transistor is connected to a first power terminal, a second electrode of the first driving transistor is connected to a first electrode of the light-emitting unit, and a gate of the first driving transistor is connected to a first node; and
a current compensation circuit, wherein the current compensation circuit is connected in parallel to the first driving transistor between the first power terminal and the first electrode of the light-emitting unit, and is configured to provide, in response to a first control signal, a driving current to the light-emitting unit through the first power terminal.

16. The pixel driving circuit according to claim 6, wherein a number of the one or more parallel eighth transistors is less than a number of the one or more parallel second driving transistors.

17. The pixel driving circuit according to claim 6, wherein a number of the one or more parallel ninth transistors is less than a number of the one or more parallel second driving transistors.

18. The pixel driving circuit according to claim 6, wherein the first driving transistor and the second driving transistor are operated in a saturation region, and the fifth transistor, the sixth transistor, the eighth transistor, and the ninth transistor are operated in a cut-off region and the saturation region.
